(19) United States
(12) Patent Application Publication
(10) Pub. No.: US 2010/0063868 A1
(43) Pub. Date: Mar. 11, 2010

(54) SYSTEM AND METHOD FOR TARGETING RETAIL INVESTOR COMMUNICATIONS

(76) Inventors: Matthew Bird, Bellevue, WA (US); James Marks, Bothell, WA (US)

Correspondence Address: BLACK LOWE & GRAHAM, PLLC, 701 FIFTH AVENUE, SUITE 4800, SEATTLE, WA, 98104, US

(21) Appl. No.: 12/398,902

(22) Filed: Mar. 5, 2009

Related U.S. Application Data
(60) Provisional application No. 61/034,460, filed on Mar. 6, 2008.

(51) Int. Cl. G06Q 40/00; G06Q 10/00

(52) U.S. Cl. 705/10; 705/36 R

(57) ABSTRACT

Real time market surveillance systems and methods are described that provide or timely communicate actionable intelligence to market investors. The system and methods employ Internet-based surveillance and push technologies to survey multiple market intelligence sources and engage in market analytics to provide updated, actionable intelligence to assist and enhance transactional decisions by market investors.

### CROSS REFERENCES TO RELATED APPLICATIONS

This application claims priority to and incorporates by reference in its entirety U.S. Provisional Patent Application No. 61/034,460 filed Mar. 6, 2008.

### FIELD OF THE INVENTION

This invention relates generally to Internet based transaction systems.

### BACKGROUND OF THE INVENTION

Market values of stocks and commodities vary with demand, market timing, market entry, and market activities across the globe on a 24-hour basis. Investors can make less than optimal selling, holding, and purchasing decisions if not timely appraised of updated, actionable intelligence.

### SUMMARY OF THE INVENTION

Real time market surveillance systems and methods are described that provide or timely communicate actionable intelligence to market investors. The system and methods employ Internet-based surveillance and push technologies to survey multiple market intelligence sources and engage in market analytics to provide updated, actionable intelligence to assist and enhance transactional decisions by market investors.

### BRIEF DESCRIPTION OF THE DRAWINGS

Preferred and alternative examples of the present invention are described in detail below with reference to the following drawings:

FIG. 1 schematically depicts a system diagram of a MUNCmedia Network;

FIG. 2 schematically depicts screenshots of MUNC media dashboards;

FIG. 3 schematically depicts a MUNC media report describing acquisition and sharing of market intelligence by and between authorized users;

FIGS. 4A-4D schematically depicts an exemplary campaign summary report; and

FIGS. 5A-5F schematically depicts MUNC media methods of obtaining and timely delivery actionable marketing intelligence to authorized users.

### DETAILED DESCRIPTION OF THE PARTICULAR EMBODIMENTS

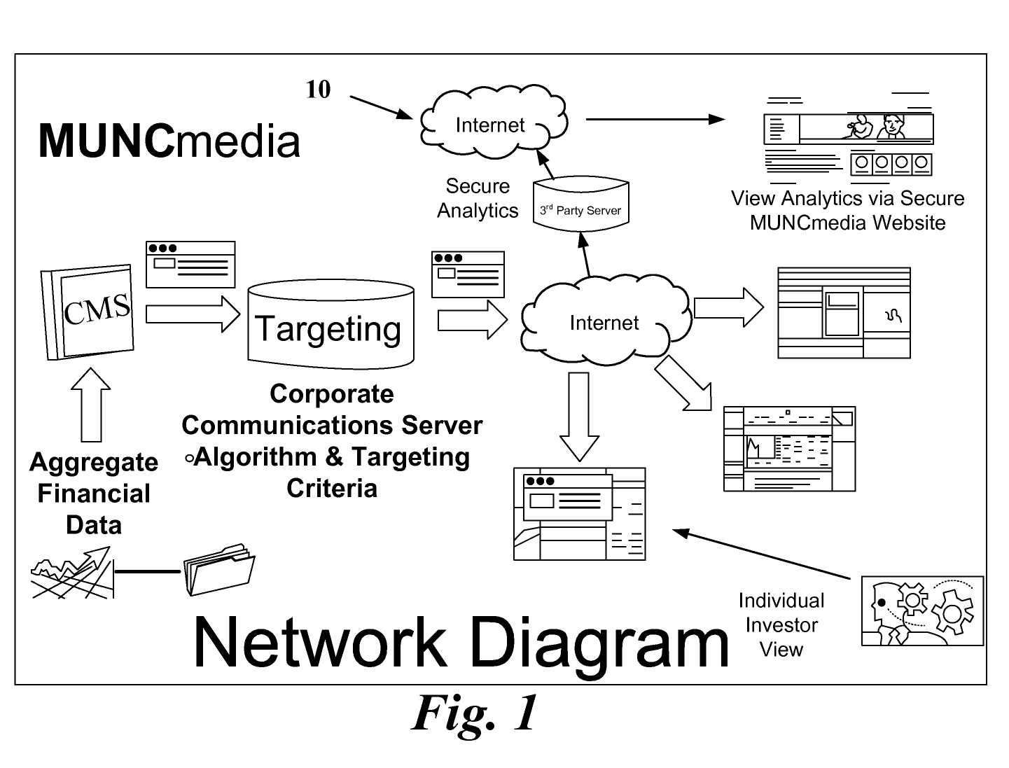

FIGS. 1-5F below illustrate particular embodiments of systems and methods for targeting retail investors and enhancing communication with retail investors.

FIG. 1 schematically depicts a system diagram 10 of a MUNCmedia Network. MUNC denotes market update network communications. The system 10 includes a content management system (CMS) that receives aggregate financial data from single and multiple sources. The CMS aggregates live market data from a data feed and corporate content that is provided by MUNCmedia's clients. The aggregated live market data and corporate content is published in a live, interactive multimedia format that is presented as an overlay on a computer screen within view of an individual investor having authorized access to a secure MUNCmedia website.

The content delivered to authorized individual investors results from MUNCmedia Servers, in communication with corporate communications servers, apply algorithms having targeting criteria regarding market entities of interest. The targeted market entities of interest are routed via the Internet to a third party servier to undergo analysis under secure protocols. Through the execution of end-users license agreements (EULA) and access via Cookies, authorized individual investors, via Internet connections, may view the Analytics from the Secure MUNCmedia Website.

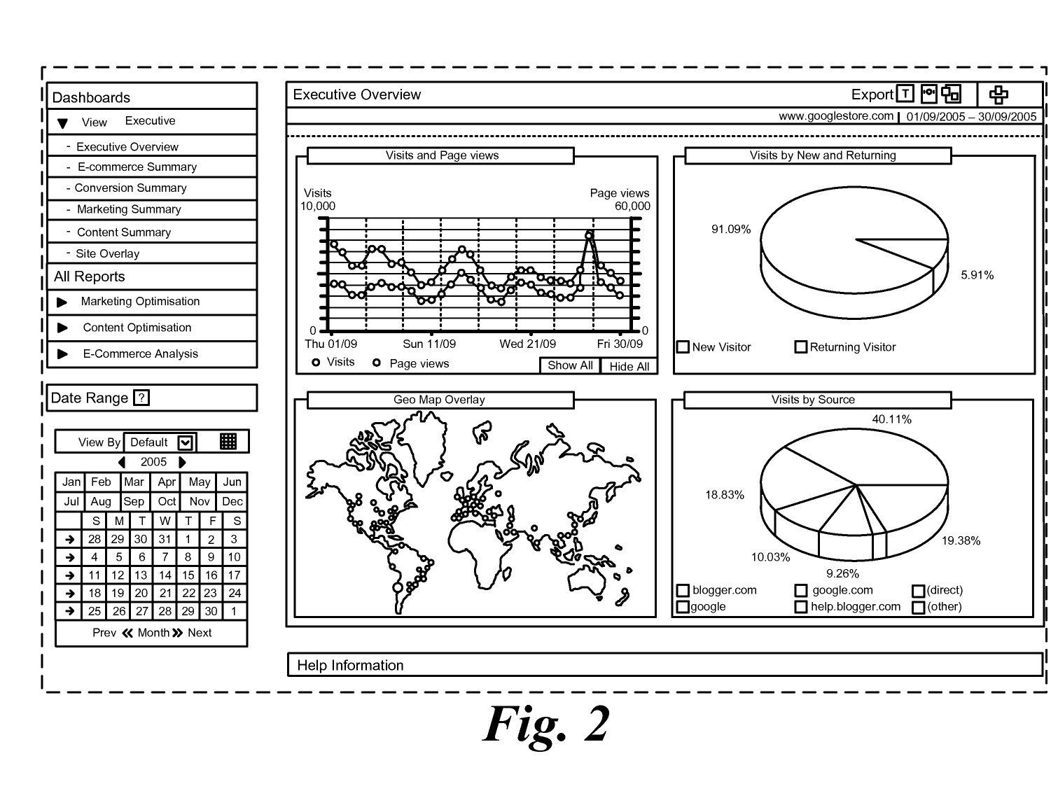

FIG. 2 schematically depicts screenshots of MUNC media dashboards. Dashboards include an executive overview, an E-commerce summary, a conversion summary, a marketing summary, a content summary, and a site overlay. An all reports section of the MUNCmedia dashboard includes market optimization, content optimization, and E-Commerce analysis. As shown the Executive Overview includes a plot of visits and page views, visits by New and Returning viewers, a geographic map overlay of market interest, and a plot of visits by source.

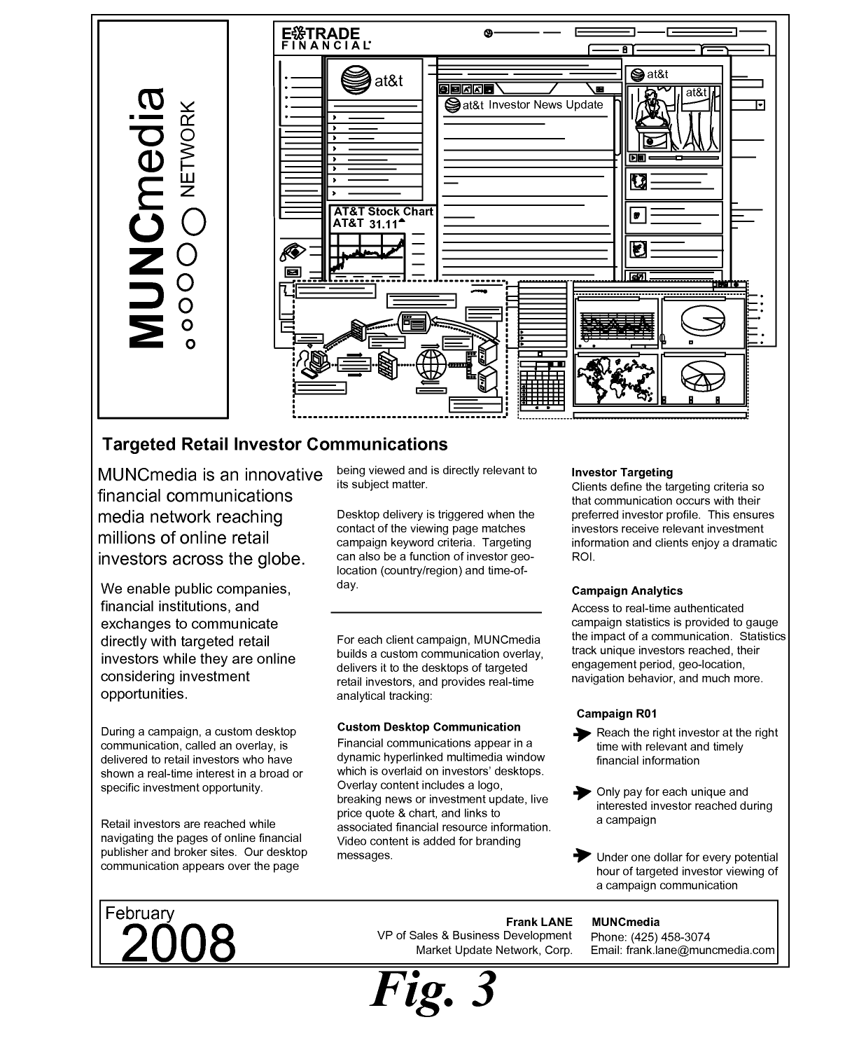

FIG. 3 schematically depicts a MUNC media report describing acquisition and sharing of market intelligence by and between authorized users. In the report a campaign return on investment (ROI) is available, along with campaign analytics.

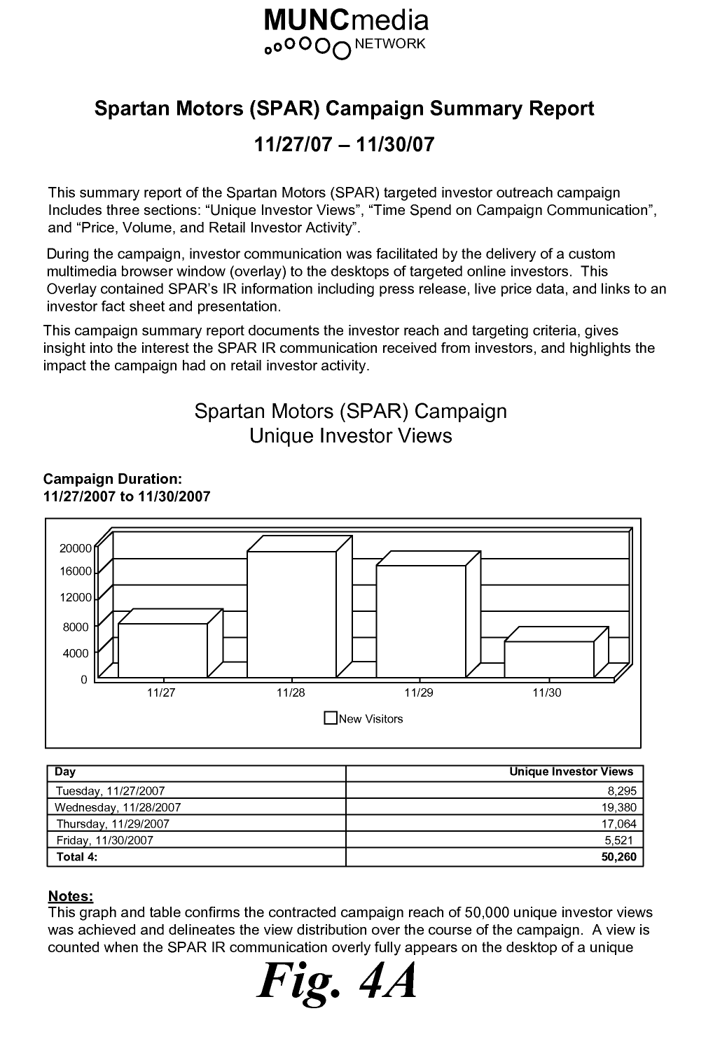

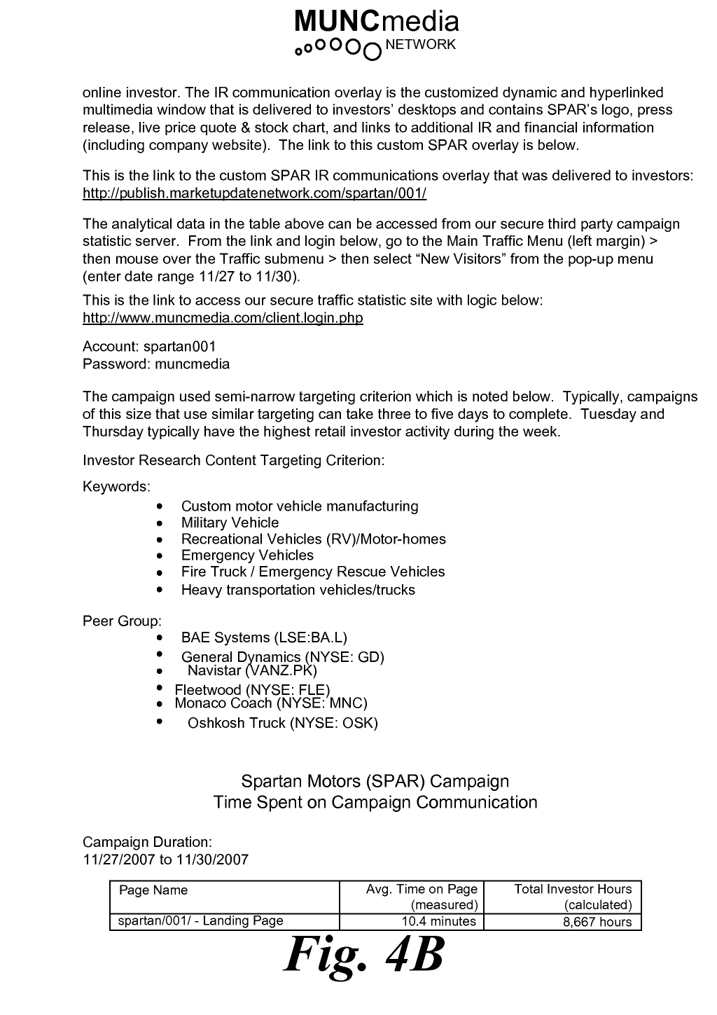

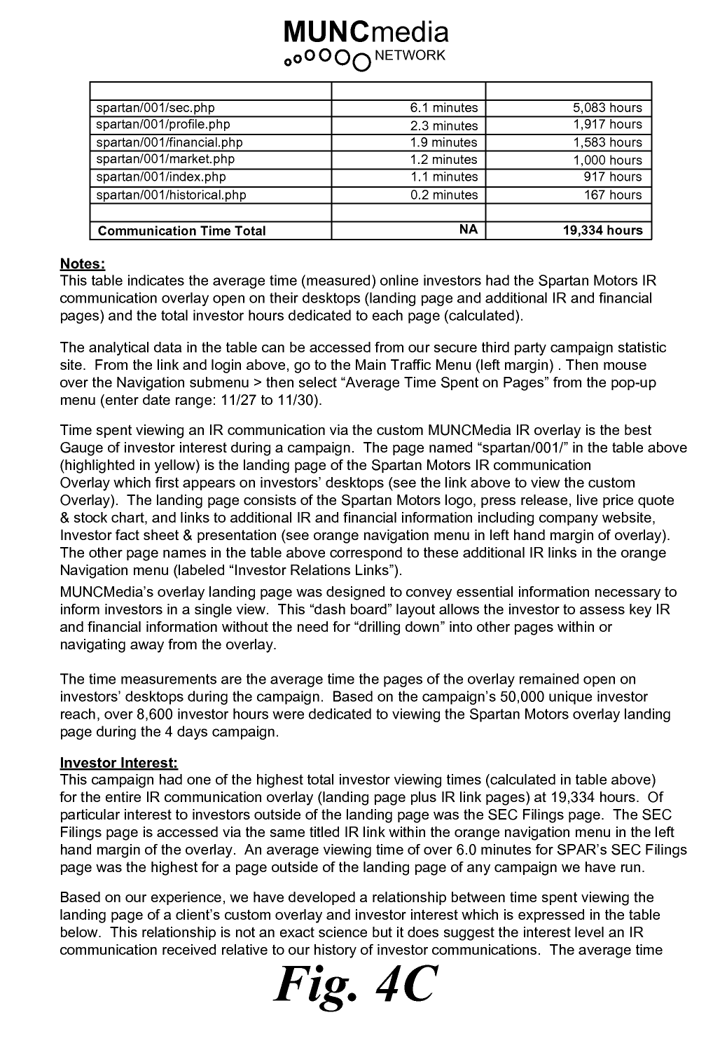

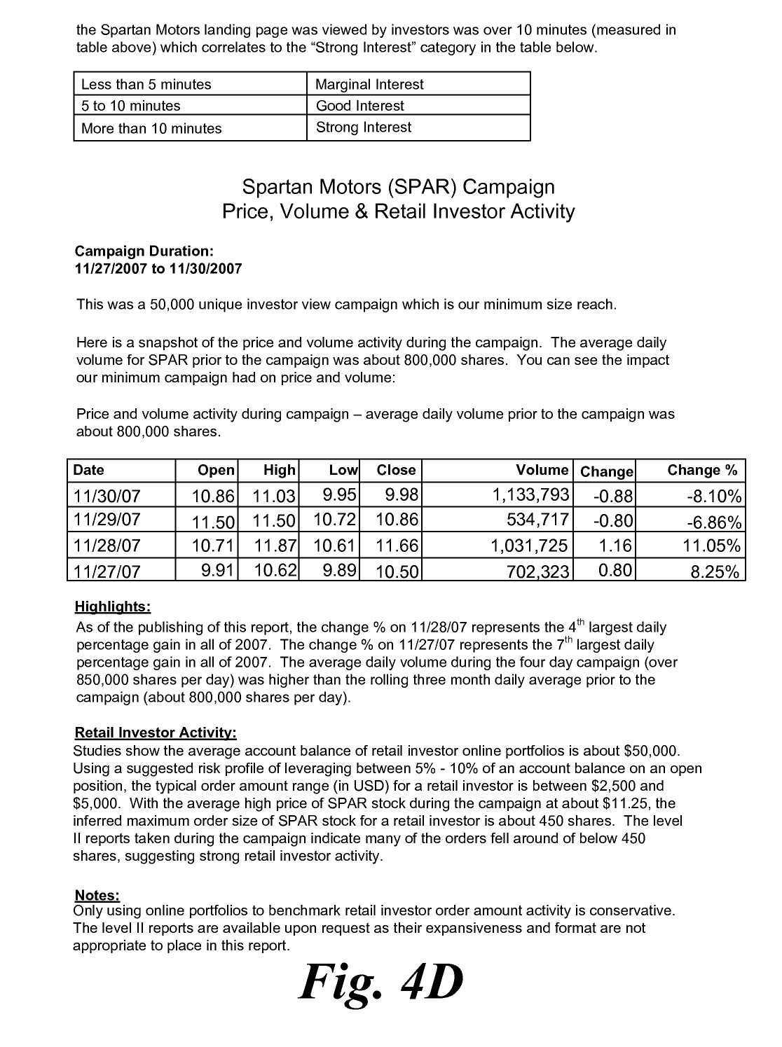

FIGS. 4A-4D schematically depicts an exemplary campaign summary report. Here an analysis for “Spartan Motors” as an exemplary market entity is detailed.

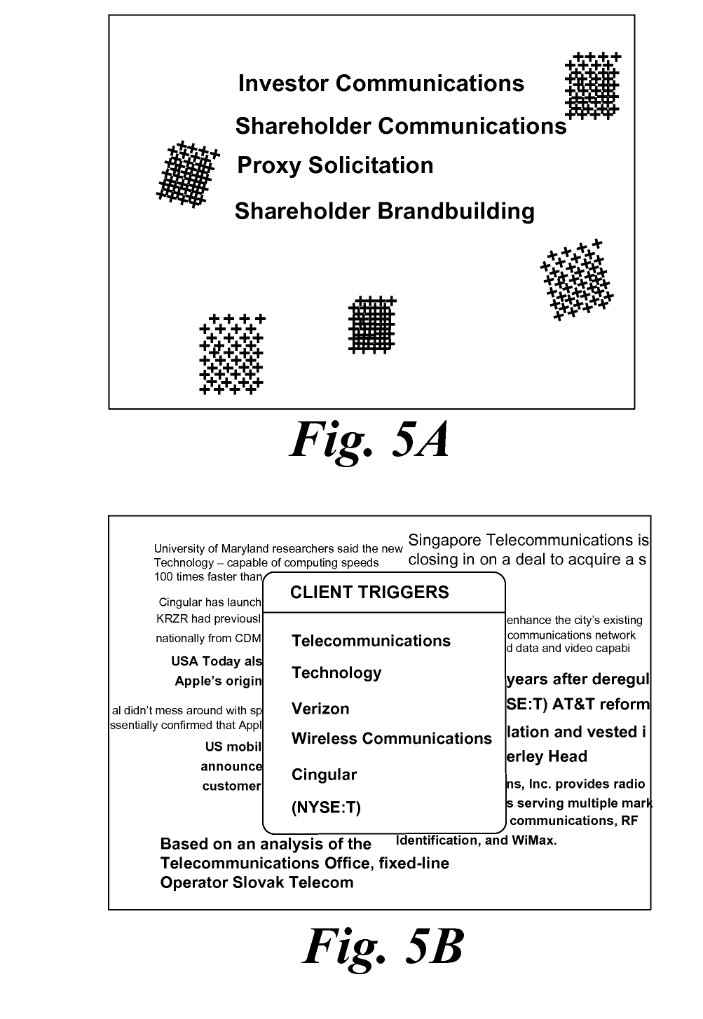

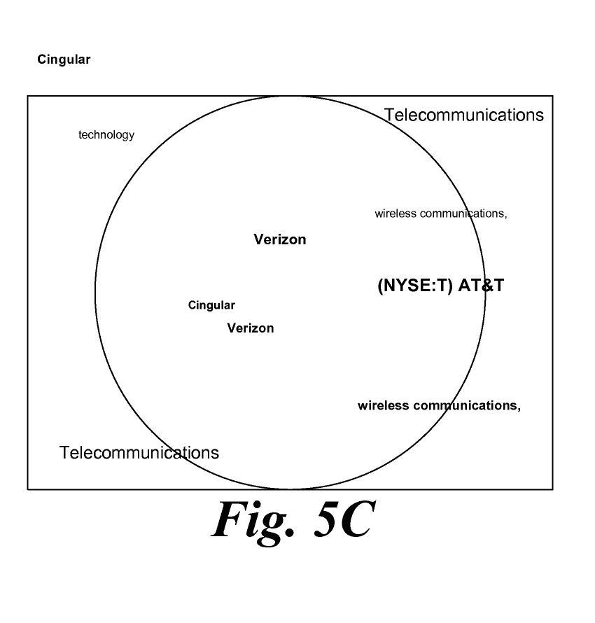

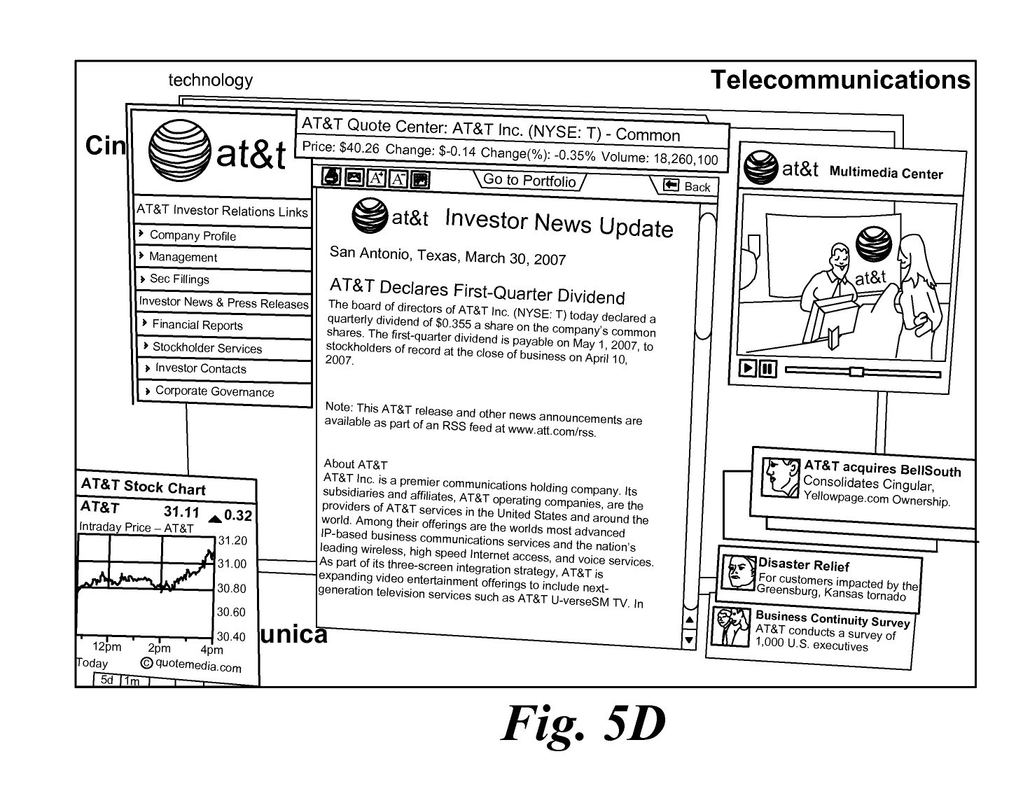

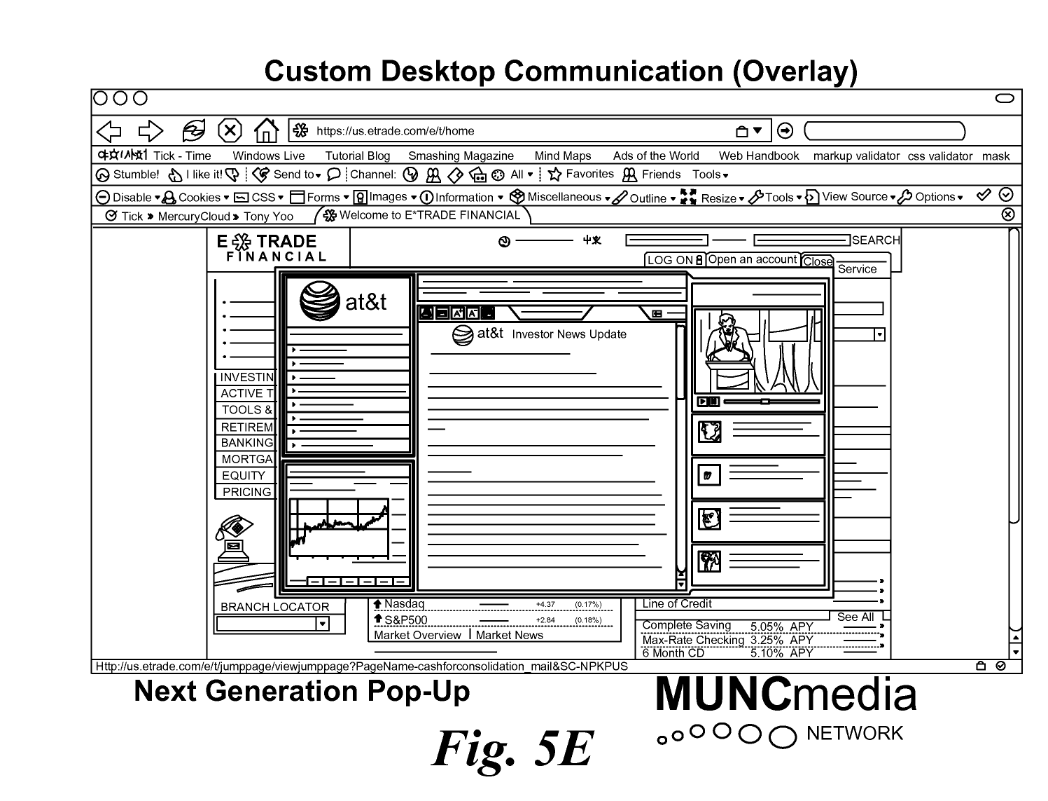

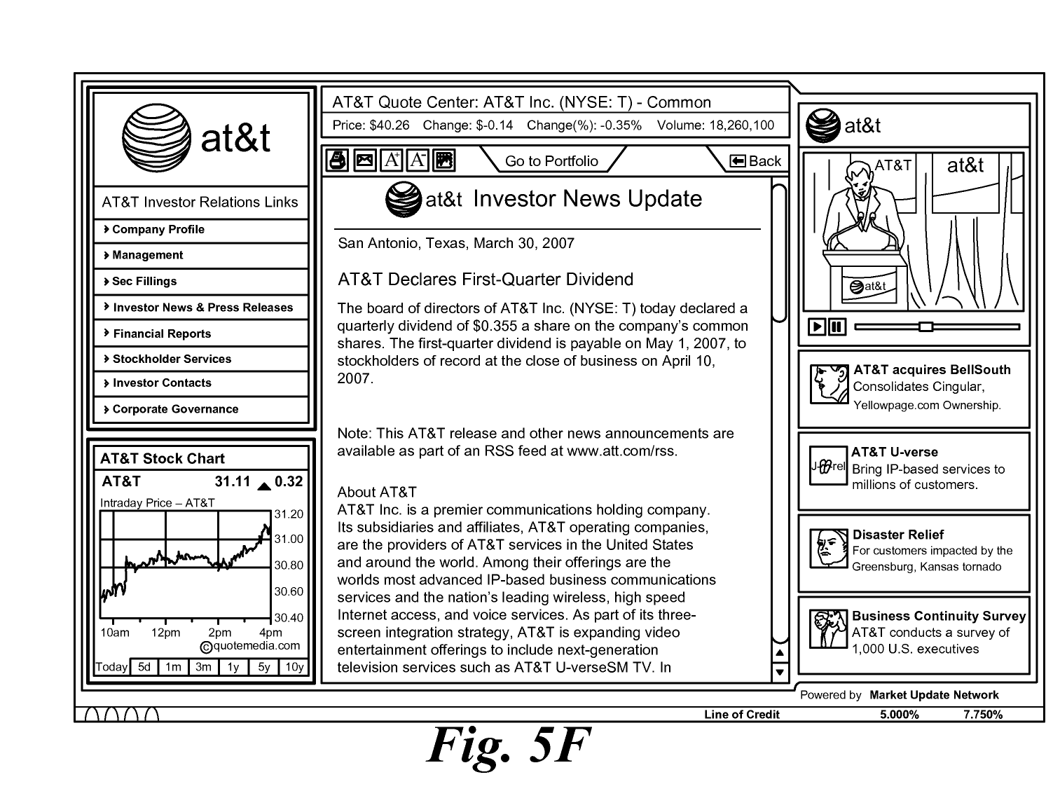

FIGS. 5A-5E schematically depicts MUNC media methods of obtaining and timely delivery actionable marketing intelligence to authorized users.

FIG. 5A schematically depicts that actionable intelligence may be a combination of any or all of investor communications, shareholder communications, proxy communications, and shareholder brand building. Other actionable intelligence is obtainable from online sources provided by at least one brokerage, bank, or stock exchange.

FIG. 5B schematically depicts an exemplary action trigger word list.

FIG. 5C schematically depicts a mapping of action word triggers on the face of a webpage.

FIG. 5D illustrates an overlay being assembled that includes reports, analytics, images, video files, graphic plots and other alphanumeric information having updated and communicated information presented in a map format from which the authorized user may utilize in reaching a conclusion for undertaken a business transaction.

FIG. 5E depicts the assembled overlay from FIG. 5D. The assembled overlay is presented over a brokerage house webpage presented on a desktop or laptop computer monitor. In this case, the assembled overlay stands out visually in bright contrast to the dim or low-contrast, brokerage house webpage seen in the background. The targeted marketing communication of the market entity appears as attention grabbing pop-ups to the authorized MUNCmedia viewing investor. In this exemplary brightly visible overlay, market intelligence reports regarding AT&T appears as an array of visibly commanding interactive multimedia pop-ups in front of a low contrast E*TRADE Financial webpage.

FIG. 5F depicts an expansion of the Investors News Update for the AT&T company.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A system for targeting retail investor communications in a local or a wide area network, the system comprising:
a computer in communication with the local or the wide area network and having a display; and
a computer readable medium installable with the computer and having instructions to survey from at least one marketing source marketing activity of a market entity, analyze the marketing activity, mapping the marketing activity, and presenting an overlay of the mapped marketing activity on the display.

2. The system of claim 1, wherein the at least one marketing source includes at least one stock brokerage, bank, and stock exchange.

3. A method for targeting retail investor communications comprising:
installing a computer readable medium in the computer, the computer readable medium having instructions for surveying from at least one marketing source marketing activity of a market entity, analyzing the marketing activity, mapping the marketing activity, and presenting an overlay of the mapped marketing activity on the display.

4. The method of claim 3, wherein surveying from at least one marketing source includes surveying at least one stock brokerage, bank, and stock exchange.
